(19) United States
(12) Patent Application Publication
(10) Pub. No.: US 2015/0118138 A1
(43) Pub. Date: Apr. 30, 2015

(54) APPARATUS AND METHOD FOR DECOMPOSING AN ULTRA-LOW CONCENTRATION OF VOLATILE ORGANIC COMPOUNDS

(71) Applicant: Korea Institute of Science and Technology, Seoul (KR)

(72) Inventors: Hyoun Duk JUNG, Seoul (KR); Jongsoo JURNG, Seoul (KR); Eun-seuk PARK, Seoul (KR); Woojoon CHA, Seoul (KR); Gwi-Nam BAE, Seoul (KR); Min Su KIM, Seoul (KR)

(73) Assignee: KOREA INSTITUTE OF SCIENCE AND TECHNOLOGY, Seoul (KR)

(21) Appl. No.: 14/528,017

(22) Filed: Oct. 30, 2014

(30) Foreign Application Priority Data
Oct. 31, 2013 (KR) 10-2013-0131531
Oct. 30, 2014 (KR) 10-2014-0149166

(51) Int. Cl. B01J 19/00

(52) U.S. Cl. CPC B01J 19/0013; B01J 2219/00051
USPC 423/245.3; 422/109

(57) ABSTRACT

Disclosed is an apparatus and method for decomposing an ultra-low concentration of volatile organic compounds, which may effectively remove ultra-low concentration of volatile organic compounds by a batch process for separating ultra-low concentration of volatile organic compounds present in an indoor air or the like and oxidizing the corresponding volatile organic compounds at a low temperature. The apparatus includes a contaminated air source for supplying a contaminated air containing volatile organic compounds, two or more absorption/desorption modules connected to the contaminated air source in parallel, a heating device provided at a circumference of each absorption/desorption module, and an oxidation decomposing catalyst device for reacting volatile organic compounds discharging from the absorption/desorption modules with oxygen atoms (O*) in an activated state so that the volatile organic compounds are oxidized and decomposed, wherein each absorption/desorption module alternately performs an absorption process and a desorption process.

### CROSS-REFERENCE TO RELATED APPLICATION

This application claims priority to Korean Patent Application No. 10-2013-0131531, filed on Oct. 31, 2013, and Korean Patent Application No. 10-2014-0149166, filed on Oct. 30, 2014 and all the benefits accruing therefrom under 35 U.S.C. §119, the contents of which in its entirety are herein incorporated by reference.

### BACKGROUND

1. Field

The present disclosure relates to an apparatus and method for decomposing an ultra-low concentration of volatile organic compounds, and more particularly, to an apparatus and method for decomposing an ultra-low concentration of volatile organic compounds, which may effectively remove ultra-low concentration of volatile organic compounds by a batch process for separating ultra-low concentration of volatile organic compounds present in an indoor air or the like and oxidizing the corresponding volatile organic compounds at a low temperature.

2. Description about National Research and Development Support

This study was supported by the Environment Fusion New-technology Development Project of the Ministry of Environment, Republic of Korea (Development of Filter Material for Controlling Contamination based Nano Technology, Project No. 1485011479), and the High-Fusion Technology Development Project of the Ministry of Science, ICT and Future Planning, Republic of Korea (Development of Decomposing Technology of Antibacterial Air-filtering and Volatile Organic Compound based Aerosol process in room temperature, Project No. 1711005882) under the superintendence of Korea Institute of Science and Technology.

3. Description of the Related Art

Volatile organic compounds (VOCs) are harmful to the human body since they contain cancerogenic chemicals, and also destroy the ozone layer and cause environmental problems such as global warming, photochemical smog and bad smell. The volatile organic compounds are present in the indoor air, and even though their concentration is very low, the volatile organic compounds give a fatal influence to the human body if a human is exposed thereto for a long time.

Volatile organic compounds may be removed by absorption using activated carbon, high-temperature incineration, oxidation by a catalyst, plasma decomposition or the like.

The absorption method using activated carbon removes volatile organic compounds by allowing activated carbon to absorb the volatile organic compounds, but the absorption performance of the activated carbon deteriorates after a long-time use. The high-temperature incineration method burns volatile organic compounds, which however is not suitable for decomposing low-concentration volatile organic compounds and consumes a great amount of fuel for heating. The oxidation method by a catalyst needs to heat the contaminated air over 300° C., and the plasma decomposition method causes other contaminants. Meanwhile, Korean Patent Registration No. 10-623498 discloses a technique for concentrating and oxidizing volatile organic compounds, which however is not suitable for the air containing ultra-low concentration of volatile organic compounds, like an indoor air. In addition, the technique disclosed in Korean Patent Registration No. 10-966481 is directed to absorbing, desorbing and cooling volatile organic compounds to be highly concentrated, and thus this technique may not be easily applied to a batch process for collecting and decomposing ultra-low concentration of volatile organic compounds.

### RELATED LITERATURES

### Patent Literature

Patent Literature 1: Korean Patent Registration No. 10-623498

Patent Literature 2: Korean Patent Registration No. 10-966481

### SUMMARY

The present disclosure is directed to providing an apparatus and method for decomposing an ultra-low concentration of volatile organic compounds, which may effectively remove ultra-low concentration of volatile organic compounds by a batch process for separating ultra-low concentration of volatile organic compounds present in an indoor air or the like and oxidizing the corresponding volatile organic compounds at a low temperature.

In one aspect, there is provided an apparatus for decomposing an ultra-low concentration of volatile organic compounds, which includes: two or more absorption/desorption modules; a heating device provided at a circumference of each absorption/desorption module; and an oxidation decomposing catalyst device for reacting volatile organic compounds discharging from the absorption/desorption modules with oxygen atoms (O*) in an activated state so that the volatile organic compounds are oxidized and decomposed, wherein each absorption/desorption module alternately performs an absorption process and a desorption process, and the absorption/desorption modules perform different processes at the same time.

In one aspect, the apparatus according to the present disclosure may further include an inflow portion of contaminated air for supplying a contaminated air containing volatile organic compounds.

In one aspect, the absorption/desorption modules may be connected to the inflow portion of contaminated air, more specifically in parallel.

In one aspect, the absorption/desorption modules which are included to the apparatus according to the present disclosure may be two or more, three or more, four or more, five or more, six or more, or seven or more, specifically the absorption/desorption modules may be two.

The absorption/desorption module may include an inlet portion, an absorption portion and a desorption portion having a sealed chamber shape and subsequently arranged to be adjacent to each other, an absorbent for absorbing volatile organic compounds may be provided in the absorption portion, and the desorption portion may temporarily store volatile organic compounds desorbed from the absorbent, and then transfer volatile organic compounds to the oxidation decomposing catalyst device. The absorbent may be zeolite.

For the absorption/desorption module which performs the desorption process, the supply of a contaminated air may be blocked and the heating device may be operated, and for the absorption/desorption module which performs the absorption process, a contaminated air may be supplied and the operation of the heating device may be stopped.

An ozonolysis catalyst for decomposing ozone to generate oxygen atoms (O*) in an activated state may be provided in the oxidation decomposing catalyst device, and an ozone supply unit for supplying ozone to the oxidation decomposing catalyst device may be further provided at one side of the oxidation decomposing catalyst device. In addition, the ozonolysis catalyst may be any one selected from the group consisting of MnO₂, NiO, CoO, Fe₂O₃, V₂O₅, AgO₂, and their mixtures.

In another aspect, there is provided a method for decomposing an volatile organic compounds by using an apparatus for decomposing an ultra-low concentration of volatile organic compounds, wherein the apparatus for decomposing an ultra-low concentration of volatile organic compounds includes: two or more absorption/desorption modules; a heating device provided at a circumference of each absorption/desorption module; and an oxidation decomposing catalyst device for reacting volatile organic compounds discharging from the absorption/desorption modules with oxygen atoms (O*) in an activated state so that the volatile organic compounds are oxidized and decomposed, wherein each absorption/desorption module alternately performs an absorption process and a desorption process, and the absorption/desorption modules perform different processes at the same time, wherein the absorption process allows volatile organic compounds to be absorbed to an absorbent of the absorption/desorption module, and the desorption process allows the volatile organic compounds absorbed to the absorbent of the absorption/desorption module to be desorbed therefrom, and wherein during the desorption process, the heating device raises a heating temperature as time goes.

The apparatus and method for decomposing an ultra-low concentration of volatile organic compounds according to the present disclosure gives the following effects.

Since the processes of absorbing, desorbing and decomposing volatile organic compounds are performed in a batch, the volatile organic compounds may be treated very efficiently. In addition, since two or more absorption/desorption modules are alternately used to perform an absorption process and a desorption process, it is possible to continuously absorb volatile organic compounds and regenerate an absorbent. In addition, by constantly maintaining the concentration of volatile organic compounds desorbed from the absorbent, the decomposition efficiency of volatile organic compounds may be maintained highly.

### BRIEF DESCRIPTION OF THE DRAWINGS

FIG. 1 is a schematic diagram showing an apparatus for decomposing an ultra-low concentration of volatile organic compounds according to an embodiment of the present disclosure.

FIG. 2 is a graph showing an acetaldehyde absorption characteristic of a regenerated absorbent.

FIG. 3 shows a concentration of acetaldehyde desorbed from an absorbent according to time when a heating device raises a temperature by 1° C. per minute.

FIG. 4 shows a concentration of acetaldehyde desorbed from an absorbent according to time when the heating device fixes a temperature to 100° C.

FIG. 5 is a graph showing a characteristic of an ozonolysis catalyst applied to an oxidation decomposing catalyst device.

FIG. 6 shows a concentration of toluene desorbed from an absorbent according to time when a heating device raises a temperature by 4° C. per minute.

FIG. 7 is a graph showing a decomposing efficiency of acetaldehyde and a concentration of residual ozone when ozone was provided constantly, and a concentration of desorbed acetaldehyde is different each other.

### DETAILED DESCRIPTION

In an exemplary embodiment of the present disclosure, the absorption/desorption module may be two or more, three or more, four or more, five or more, six or more, seven or more, eight or more, nine or more, or ten or more, and specifically two or more, three or more, or four or more.

In an exemplary embodiment of the present disclosure, the heating device may comprise a temperature control unit.

In an exemplary embodiment of the present disclosure, the temperature control unit may control a temperature in order to constantly maintain a concentration of the volatile organic compounds, which are discharged from the absorption/desorption module and supplied to the catalyst device.

In an exemplary embodiment of the present disclosure, the concentration (C) of the discharged and supplied volatile organic compounds may be within a range of a following mathematical equation 1.

0.8*Cₒ≦C≦1.2*Cₒ [Mathematical equation 1]

(Cₒ is a mean concentration of the volatile organic compounds which are discharged from the absorption/desorption module).

In an exemplary embodiment of the present disclosure, the controlling of temperature by the temperature control unit may comprise setting-up a start temperature (Tₛ) and end temperature (Tₑ), and then, in at least one heating periods, which are intervals between the start temperature and end temperature, and raising the temperature at a specific rate per 1 minute.

In an exemplary embodiment of the present disclosure, the start temperature and the end temperature may have a relation according to a following mathematical equation 2.

Tₛ+A*t=Tₑ [Mathematical equation 2]

wherein “A” is a rate of temperature elevation per 1 minute, and “t” is total time (minutes) of the heating periods.

In an exemplary embodiment of the present disclosure, the rate of temperature elevation per 1 minute may be 0.1° C.˜8° C. Specifically, in one aspects, the rate of temperature elevation per 1 minute may be 0.1° C. or more, 0.2° C. or more, 0.3° C. or more, 0.4° C. or more, 0.5° C. or more, 0.6° C. or more, 0.7° C. or more, 0.8° C. or more, 0.9° C. or more, 1.0° C. or more, 1.1° C. or more, 1.2° C. or more, 1.3° C. or more, 1.4° C. or more, 1.5° C. or more, 1.6° C. or more, 1.7° C. or more, 1.8° C. or more, 1.9° C. or more, 2.0° C. or more, 2.5° C. or more, 3.0° C. or more, 3.5° C. or more, 3.6° C. or more, 3.7° C. or more, 3.8° C. or more, 3.9° C. or more, 4.0° C. or more, 4.1° C. or more, 4.2° C. or more, 4.3° C. or more, 4.4° C. or more, 4.5° C. or more, 5.0° C. or more, 5.5° C. or more, or 6.0° C. or more. Specifically, in another aspects, the rate of temperature elevation per 1 minute may be 8.0° C. or less, 7.5° C. or less, 7.0° C. or less, 6.5° C. or less, 6.0° C. or less, 5.5° C. or less, 5.0° C. or less, 4.5° C. or less, 4.4° C. or less, 4.3° C. or less, 4.2° C. or less, 4.1° C. or less, 4.0° C. or less, 3.9° C. or less, 3.8° C. or less, 3.7° C. or less, 3.6° C. or less, 3.5° C. or less, 3.0° C. or less, 2.5° C. or less, 2.0° C. or less, 1.9° C. or less, 1.8° C. or less, 1.7° C. or less, 1.6° C. or less, 1.5° C. or less, 1.4° C. or less, 1.3° C. or less, 1.2° C. or less, 1.1° C. or less, 1.0° C. or less, 0.9° C. or less, 0.8° C. or less, 0.7° C. or less, 0.6° C. or less, 0.5° C. or less, 0.4° C. or less, 0.3° C. or less, 0.2° C. or less, or 0.1° C. or less.

In an exemplary embodiment of the present disclosure, the rate of temperature elevation per 1 minute may vary depend on a type of volatile organic compounds. For example, if a volatile organic compounds is acetaldehyde, the rate of temperature elevation per 1 minute may be 0.7˜1.3° C., more specifically 0.8˜1.2° C. Further, if a volatile organic compounds is toluene, the rate of temperature elevation per 1 minute may be 3˜5° C., more specifically 3.8˜4.2° C.

In an exemplary embodiment of the present disclosure, the controlling temperature by the temperature control unit may comprise maintaining the temperature in at least one temperature maintaining periods, and the temperature maintaining periods may locate in between heating periods or after a heating period.

The present disclosure is directed to providing a method for decomposing an ultra-low concentration of volatile organic compounds in the air, which comprising:

absorbing and desorbing volatile organic compounds in the air by using two or more modules and supplying the absorbed or desorbed volatile organic compounds; and

decomposing the supplied volatile organic compounds by reacting the supplied volatile organic compounds with oxygen atoms (O*) in an activated state.

In an exemplary embodiment of the present disclosure, the absorbing and desorbing processes are alternately performed in different modules, and the absorbing and desorbing processes are performed at the same time by different modules so that while one module performs the absorbing process, another module performs the desorbing process to regenerate an absorbent, thereby successively performing the absorbing and desorbing processes.

In an exemplary embodiment of the present disclosure, the desorbing and supplying may be carried out so that concentration of the volatile organic compounds may be constantly maintained to be within a range of following mathematical equation 1.

0.8*Cₒ≦C≦1.2*Cₒ [Mathematical equation 1]

(Cₒ is a mean concentration of the volatile organic compounds which are discharged from the absorption/desorption module and supplied to the oxygen atoms).

In an exemplary embodiment of the present disclosure, the supplying may be transferring the volatile organic compounds by heating the absorption/desorption module.

In an exemplary embodiment of the present disclosure, the heating may be setting-up a start temperature (Tₛ) and end temperature (Tₑ), and then, in at least heating periods, which are intervals between the start temperature and end temperature, and raising the temperature at a specific rate per 1 minute.

In an exemplary embodiment of the present disclosure, the heating may further comprise maintaining the temperature in at least one temperature maintaining periods, and the temperature maintaining periods may locate in between heating periods or after a heating period.

In an exemplary embodiment of the present disclosure, the heating periods may be one minute to one hundred minute, and the temperature maintaining periods may be one minute to sixty minute. Specifically, in one aspects of the present disclosure, the heating periods may be 1 minute or more, 2 minutes or more, 3 minutes or more, 4 minutes or more, 5 minutes or more, 6 minutes or more, 10 minutes or more, 15 minutes or more, 20 minutes or more, 25 minutes or more, 30 minutes or more, 35 minutes or more, 40 minutes or more, 45 minutes or more, 50 minutes or more, 60 minutes or more, 70 minutes or more, 80 minutes or more, 90 minutes or more, or 100 minutes or more. Specifically, in one aspects of the present disclosure, the heating periods may be 120 minutes or less, 110 minutes or less, 100 minutes or less, 90 minutes or less, 80 minutes or less, 70 minutes or less, 60 minutes or less, 50 minutes or less, 45 minutes or less, 40 minutes or less, 35 minutes or less, 30 minutes or less, 25 minutes or less, 20 minutes or less, 15 minutes or less, 10 minutes or less, 8 minutes or less, 6 minutes or less, 5 minutes or less, 4 minutes or less, 3 minutes or less, 2 minutes or less, or 1 minute or less.

Specifically, in one aspects of the present disclosure, the temperature maintaining periods may be 1 minutes or more, 5 minutes or more, 7 minutes or more, 9 minutes or more, 10 minutes or more, 11 minutes or more, 13 minutes or more, 15 minutes or more, 17 minutes or more, 20 minutes or more, 25 minutes or more, 30 minutes or more, 40 minutes or more, 50 minutes or more, or 60 minutes or more.

Specifically, in one aspects of the present disclosure, the temperature maintaining periods may be 60 minutes or less, 50 minutes or less, 40 minutes or less, 30 minutes or less, 25 minutes or less, 20 minutes or less, 17 minutes or less, 15 minutes or less, 13 minutes or less, 11 minutes or less, 10 minutes or less, 9 minutes or less, 7 minutes or less, 5 minutes or less, or 1 minute or less.

In one aspects of the present disclosure, the start temperature may be 20˜30° C., the end temperature may be 110˜130° C., the rate of the temperature elevation per 1 minute may be 0.7˜1.3° C., the heating period may be 80˜100 minutes, the temperature maintaining period may be 15˜25 minutes after the heating period. Further, in one aspects of the present disclosure, a pressure of the module in desorbing may be 0.75˜0.85 atm. Further, in one aspects of the present disclosure, a flow rate of a nitrogen gas may be 0.8˜1.2 L/min. The above mentioned condition may apply to acetaldehyde.

In one aspects of the present disclosure, the start temperature may be 20˜30° C., the end temperature may be 130˜150° C., a number of the heating periods may be four or five, the rate of the temperature elevation per 1 minute may be 35° C., each of the heating period may be 4˜6 minutes, each of the temperature maintaining period which is located between each of the heating period may be 13˜17 minutes. Further, in one aspects of the present disclosure, a pressure of the module in desorbing may be 0.75˜0.85 atm. Further, in one aspects of the present disclosure, a flow rate of a nitrogen gas may be 0.4˜-0.6 L/min. The above mentioned condition may apply to toluene.

In one aspects of the present disclosure, the pressure of the module in desorbing may be 0.5˜0.9 atm. Specifically, the pressure of the module in desorbing may be 0.1 atm or more, 0.3 atm or more, 0.5 atm or more, 0.6 atm or more, 0.7 atm or more, 0.8 atm or more, 0.9 atm or more, or 1.0 atm or more. Further, specifically, the pressure of the module in desorbing may be 1.0 atm or less, 0.9 atm or less, 0.8 atm or less, 0.7 atm or less, 0.6 atm or less, 0.5 atm or less, 0.3 atm or less, or 0.1 atm or less.

In one aspects of the present disclosure, the desorbing may be performed by providing a carrier gas to the module at a 0.1˜2 L/min of flow rate. Specifically, the flow rate of the carrier gas may be 0.1 L/min or more, 0.2 L/min or more, 0.3 L/min or more, 0.4 L/min or more, 0.5 L/min or more, 0.6 L/min or more, 0.7 L/min or more, 0.8 L/min or more, 0.9 L/min or more, 1.0 L/min or more, 1.1 L/min or more, 1.2 L/min or more, 1.3 L/min or more, 1.4 L/min or more, 1.5 L/min or more, or 2.0 L/min or more. Specifically, the flow rate of the carrier gas may be 3.0 L/minor less, 2.5 L/minor less, 2.0 L/minor less, 1.5 L/minor less, 1.4 L/minor less, 1.3 L/minor less, 1.2 L/minor less, 1.1 L/minor less, 1.0 L/minor less, 0.9 L/minor less, 0.8 L/minor less, 0.7 L/minor less, 0.6 L/minor less, 0.5 L/minor less, 0.4 L/minor less, 0.3 L/minor less, 0.2 L/minor less, or 0.1 L/minor less.

In one aspects of the present disclosure, the carrier gas may be hydrogen, helium, argon, or nitrogen gas.

In one aspects of the present disclosure, the module may comprise an absorbent therein.

In one aspects of the present disclosure, the absorbent may be zeolite.

In one aspects of the present disclosure, the number of modules may be two.

In one aspects of the present disclosure, the oxygen atoms (O*) in an activated state may be generated by a reaction of an ozonolysis catalyst and ozone.

In one aspects of the present disclosure, the ozonolysis catalyst may be selected from the group consisting of MnO₂, NiO, CoO, Fe₂O₃, V₂O₅, AgO₂, and mixtures thereof.

The present disclosure proposes a technique for effectively removing ultra-low concentration of volatile organic compounds by successively absorbing, desorbing and decomposing volatile organic compounds. In detail, an absorption/desorption module capable of absorbing and desorbing volatile organic compounds is configured in two or more stages, and two or more absorption/desorption modules are alternately operated so that an absorbent is recycled and successively absorbs volatile organic compounds and also the desorbed volatile organic compounds are supplied to an oxidation decomposing catalyst device with an optimal decomposition concentration to perfectly decompose the volatile organic compounds. Hereinafter, an apparatus and method for decomposing an ultra-low concentration of volatile organic compounds according to an embodiment of the present disclosure will be described with reference to the accompanying drawings, especially when the absorption/desorption modules are two or two-stage.

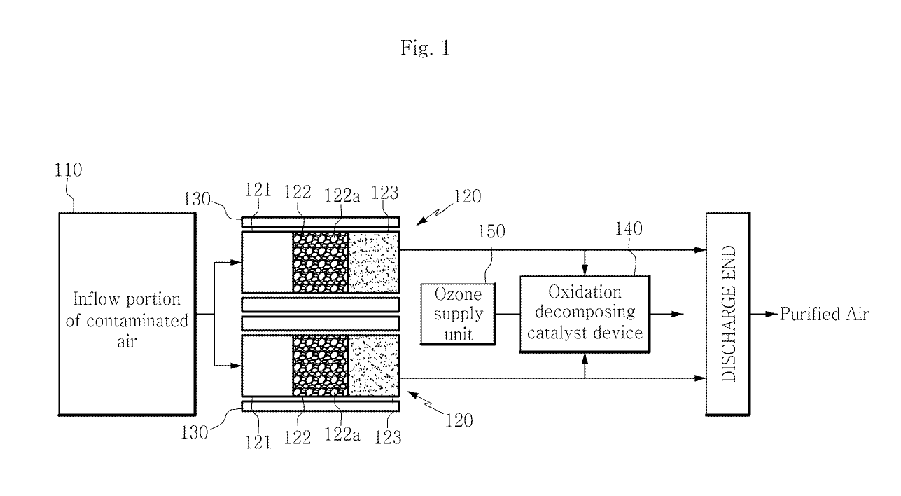

Referring to FIG. 1, the apparatus for decomposing an ultra-low concentration of volatile organic compounds according to an embodiment of the present disclosure includes two-stage absorption/desorption modules 120 and an oxidation decomposing catalyst device 140.

A inflow portion of contaminated air 110 for supplying a contaminated air containing volatile organic compounds is provided at a front end of the two-stage absorption/desorption modules 120, and the inflow portion of contaminated air 110 is connected to the two absorption/desorption modules 120 in parallel and supplies a contaminated air to the absorption/desorption module 120. Supplement of the contaminated air may be performed through a connection unit which connects the inflow portion of contaminated air and the absorption/desorption modules.

The absorption/desorption module 120 absorbs volatile organic compounds present in the air by means of an absorbent 122a and desorbs the volatile organic compounds absorbed to the absorbent 122a, and includes an inlet portion 121, an absorption portion 122 and a desorption portion 123 in detail. A heating device 130 is provided at a circumference of the absorption/desorption module 120.

The inlet portion 121, the absorption portion 122 and the desorption portion 123 have a sealed chamber shape separated from the outer circumstance, and the chambers configuring the inlet portion 121, the absorption portion 122 and the desorption portion 123 are subsequently arranged to be adjacent to each other. The inlet portion 121 gives a space through which an air containing volatile organic compounds flows in, the absorption portion 122 absorbs volatile organic compounds present in the air by means of the absorbent 122a, and the desorption portion 123 temporarily stores volatile organic compounds desorbed from the absorbent 122a of the absorption portion 122, and transfer volatile organic compounds to the oxidation decomposing catalyst device. The desorbing or discharging of the volatile organic compounds may be performed through a connection unit which connects and the absorption/desorption modules and the oxidation decomposing catalyst device, and may be performed by providing a carrier gas to the modules.

The absorbent 122a provided at the absorption portion 122 may employ a carrier based on non-activated carbon with a large specific surface area, for example zeolite. Zeolite is used as the absorbent 122a of volatile organic compounds since zeolite requires a relatively lower temperature for desorbing volatile organic compounds in comparison to activated carbon and a residue amount of volatile organic compounds in the absorbent is relatively lower in the desorbing process. Activated carbon demands a high temperature over 300° C. for desorption, but in case of zeolite, volatile organic compounds are desorbed at about 100° C.

The heating device 130 is provided at the circumference of the absorption/desorption module 120 to desorb volatile organic compounds absorbed to the absorbent 122a, and the volatile organic compounds may be desorbed from the absorbent 122a by the operation of the heating device 130.

In the present disclosure, two or more absorption/desorption modules 120 are arranged in parallel so that an absorption process and a desorption process are performed simultaneously to enhance the treatment efficiency of volatile organic compounds and ensure a recycling time of the absorbent 122a. For example, If a first absorption/desorption module 120 at an upper side performs an absorption process, a second absorption/desorption module 120 at a lower side may be operated to perform a desorption process. In this way, the first absorption/desorption module 120 and the second absorption/desorption module 120 may perform the absorption process and the desorption process alternately. At this time, for the absorption/desorption module 120 which performs the desorption process, a contaminated air is not supplied, and the heating device 130 is operated thereto. In case the absorption/desorption module 120 absorption process, the operation of the heating device 130 is stopped. Since each absorption/desorption module 120 performs the absorption process and the desorption process alternately, when the first absorption/z module 120 performs the absorption process, the second absorption/desorption module 120 may perform the desorption process to recycle the absorbent 122a. In addition, since either of two absorption/desorption modules 120 continuously performs the desorption process while the absorption process is performed, volatile organic compounds may be treated more efficiently.

Meanwhile, the oxidation decomposing catalyst device 140 receives volatile organic compounds from the desorption portion 123 and decomposes the corresponding volatile organic compounds. In detail, the oxidation decomposing catalyst device 140 includes an ozonolysis catalyst for decomposing ozone (O₃). The ozonolysis catalyst dissociates ozone into oxygen atoms (O*) in an activated state, and the oxygen atoms (O*) in an activated state formed by the ozonolysis catalyst react with volatile organic compounds to oxidize and decompose the volatile organic compounds.

The ozonolysis catalyst for decomposing the ozone may use any one selected from the group consisting of MnO₂, NiO, CoO, Fe₂O₃, V₂O₅, AgO₂ and their mixtures. In addition, in order to form the oxygen atoms (O*) in an activated state by the ozonolysis catalyst, an ozone supply unit 150 for supplying ozone into the oxidation decomposing catalyst device 140 may be provided at one side of the oxidation decomposing catalyst device 140.

Heretofore, the apparatus for decomposing an ultra-low concentration of volatile organic compounds according to an embodiment of the present disclosure have been described. Next, operations of the apparatus for decomposing an ultra-low concentration of volatile organic compounds according to an embodiment of the present disclosure will be described.

Two absorption/desorption modules 120 are connected to the inflow portion of contaminated air 110 in parallel, and in a state where two absorption/desorption modules 120 perform an absorption process and a desorption process differently from each other, a contaminated air containing volatile organic compounds is supplied to the inlet portion 121 of the absorption/desorption module 120 which performs the absorption process. The contaminated air passing through the inlet portion 121 is supplied to the absorption portion 122, and the absorbent 122a in the corresponding absorption portion 122 absorbs the volatile organic compounds contained in the contaminated air. This absorption process is performed for a predetermined period, and if the absorption process is completed in the corresponding absorption/desorption module 120, the desorption process is performed. When desorption process is performed, the introduction of the contaminated air is blocked, and the heating device 130 provided at the circumference of the absorption/desorption module 120 is operated.

Due to the operation of the heating device 130, the volatile organic compounds absorbed to the absorbent 122a are desorbed therefrom, and the desorbed volatile organic compounds are transferred to the oxidation decomposing catalyst device 140 via the desorption portion 123. The volatile organic compounds moved to the oxidation decomposing catalyst device 140 react with oxygen atoms (O*) in an activated state formed in the oxidation decomposing catalyst device 140 to be oxidized and decomposed.

Meanwhile, when the desorption process is performed, since the amount of volatile organic compounds absorbed to the absorbent 122a is limited, an amount of desorbed volatile organic compounds gradually decreases as time goes. At this time, if the amount of desorbed volatile organic compounds, namely an amount of volatile organic compounds transferred to the oxidation decomposing catalyst device 140, abruptly increases or decreases, the decomposition efficiency of volatile organic compounds by the oxidation decomposing catalyst device 140 may not be constantly maintained. Therefore, in order to constantly maintain a decomposition characteristic of volatile organic compounds, the amount of desorbed volatile organic compounds, namely the amount of volatile organic compounds transferred to the oxidation decomposing catalyst device 140, should be constantly maintained. For this, in the present disclosure, the heating device 130 raises a temperature at regular intervals. At an early heating stage, the amount of volatile organic compounds absorbed to the absorbent 122a is in a maximum level, and thus a constant amount of volatile organic compounds is desorbed at a relatively low temperature. If the temperature is raised at regular intervals afterwards, even though the amount of volatile organic compounds remaining in the absorbent 122a decreases, it is possible to desorb a constant amount of volatile organic compounds.

Next, a treatment characteristic of volatile organic compounds by the apparatus for decomposing an ultra-low concentration of volatile organic compounds according to an embodiment of the present disclosure will be described.

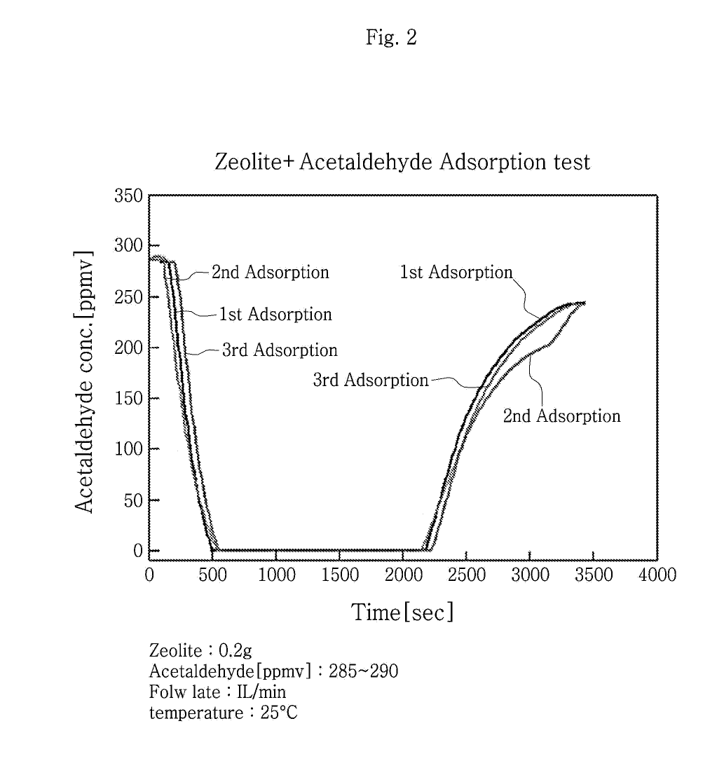

First, a absorption experiment has been repeatedly performed with respect to the absorption/desorption module of the present disclosure. In other words, after the absorption process, the absorbent was recycled by desorption, and the recycled absorbent was used for absorption again. FIG. 2 shows an acetaldehyde absorption characteristic of the recycled absorbent. In detail, after the first absorption, the absorbent was recycled and a second absorption was performed, and then the absorbent was recycled secondarily and a third absorption was performed. 0.2 g of zeolite was used as the absorbent, and an air containing acetaldehyde in a concentration of 285 to 290 ppmv was supplied to the absorbent at a flow rate of 1 L/min.

Referring to FIG. 2, it may be understood that 99.9% of acetaldehyde is removed by the absorbent in the results of the first, second and third absorptions, and from this, it may be understood that the absorbent is perfectly recycled by the desorption process.

Thus, zeolite was used in the following experiments as the absorbent. FT-IR Spectrometer (MIDAC Model I-4001 (USA), as same in the following experiments) is used to detect a concentration of acetaldehyde in this experiment.

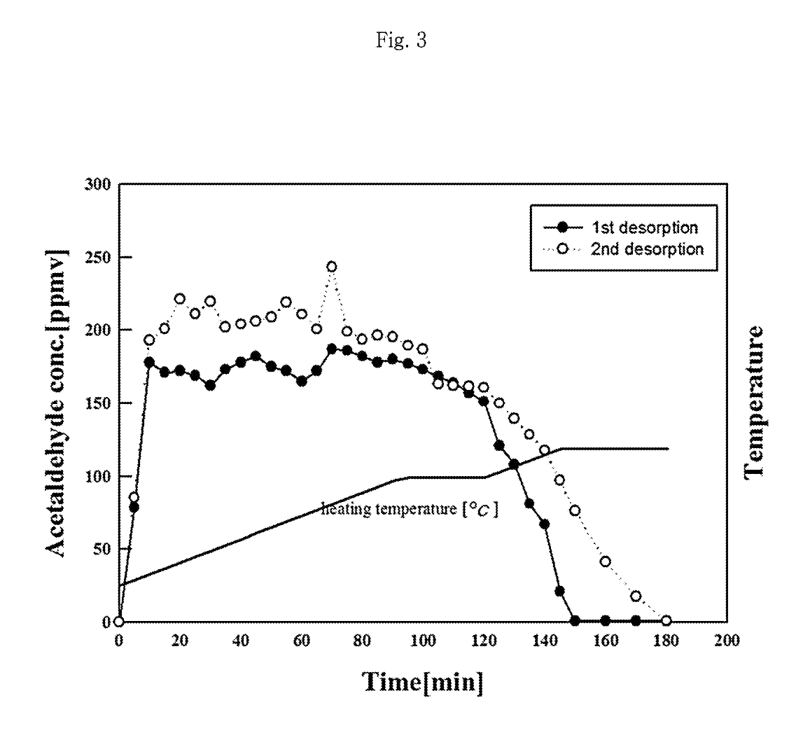

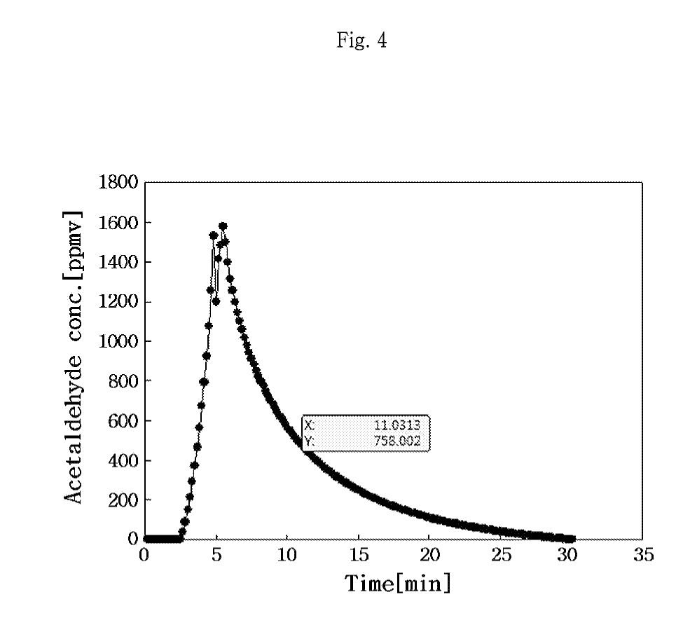

FIGS. 3 and 4 show temperature of the module and concentrations of acetaldehyde desorbed from the absorbent according to heating conditions of the heating device. Detection of the concentrations of acetaldehyde was performed by FT-IR Spectrometer and a detecting unit of the FT-IR spectrometer was located in a connection path between the module and the oxidation decomposing catalyst device. Thereby, we detected variation of the concentration.

FIG. 3 shows a temperature of the module and a concentration of acetaldehyde desorbed from an absorbent according to time when a heating device raises a temperature by 1° C. per minute, and the sealed modules were maintained in 0.8 atm, and 1 L/min of nitrogen gas were provided continuously to the module in order to transfer the desorbed acetaldehyde to the oxidation decomposing catalyst device. FIG. 4 shows a concentration of acetaldehyde desorbed from an absorbent according to time when the heating device fixes a temperature to 100° C. In the case of FIG. 3, it may be understood that the concentration of acetaldehyde desorbed from an absorbent is constantly maintained in the level of 190±25 ppm for about 100 minutes. Meanwhile, in the case of FIG. 4 where the temperature of the heating device is fixed to 100° C., it may be found that the concentration of acetaldehyde desorbed from the absorbent abruptly increases and then rapidly decreases. Therefore, the concentration of acetaldehyde desorbed from the absorbent may be constantly maintained if the heating device raises the temperature at regular intervals, and it may also be understood that the decomposition efficiency of volatile organic compounds by the oxidation decomposing catalyst device may be ensured to a certain level. For reference, in the experiment of FIG. 3, the temperature was raised from 25° C. to 120° C. and maintained at 120° C. for 20 minutes.

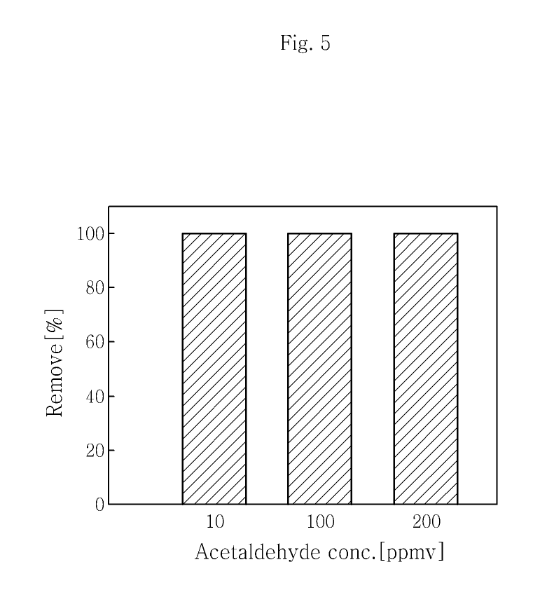

FIG. 5 is a graph showing a characteristic of an ozonolysis catalyst applied to the oxidation decomposing catalyst device, which illustrates an acetaldehyde decomposition characteristic when MnO₂—TiO₂ is applied as the ozonolysis catalyst. As shown in FIG. 5, it may be understood that acetaldehyde is entirely decomposed and removed regardless of the concentration of acetaldehyde.

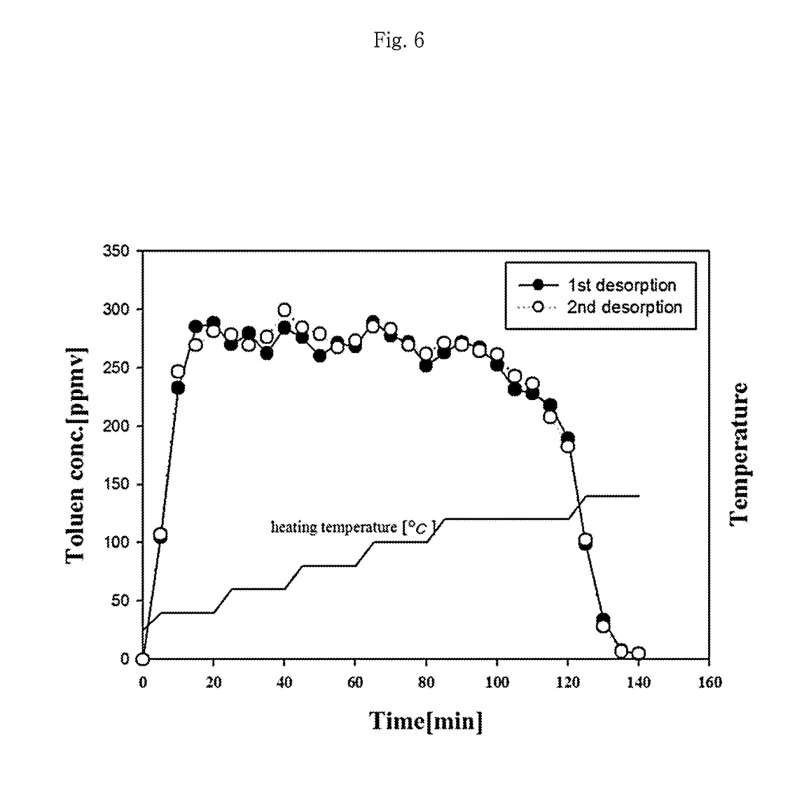

FIG. 6 is a desorbing experiment for toluene. FIG. 6 shows temperature of the module and a concentration of toluene desorbed from an absorbent according to time when a heating device raises a temperature by 4° C. per minute, and the sealed modules were maintained in 0.8 atm, and 0.5 L/min of nitrogen gas were provided continuously to the module in order to transfer the desorbed acetaldehyde to the oxidation decomposing catalyst device. The heating periods were set-up to 5 minutes, and the temperature maintained periods were set-up to 15 minutes. The heating was repeated until the temperature of the module reach to the end temperature, and the heating was performed by raising the temperature in 5 minutes and then maintain the temperature in 15 minutes. The start temperature of the module was set-up to 25° C., and the end temperature was set-up to 140° C. Detection of the concentrations of toluene was same as the methods of FIG. 3.

According to FIG. 6, it may be understood that the concentration of toluene desorbed from an absorbent is constantly maintained in the level of 270±20 ppm for about 100 minutes. Therefore, the concentration of acetaldehyde desorbed from the absorbent may be constantly maintained if the heating device raises the temperature at regular intervals, and it may also be understood that the decomposition efficiency of volatile organic compounds by the oxidation decomposing catalyst device may be ensured to a certain level.

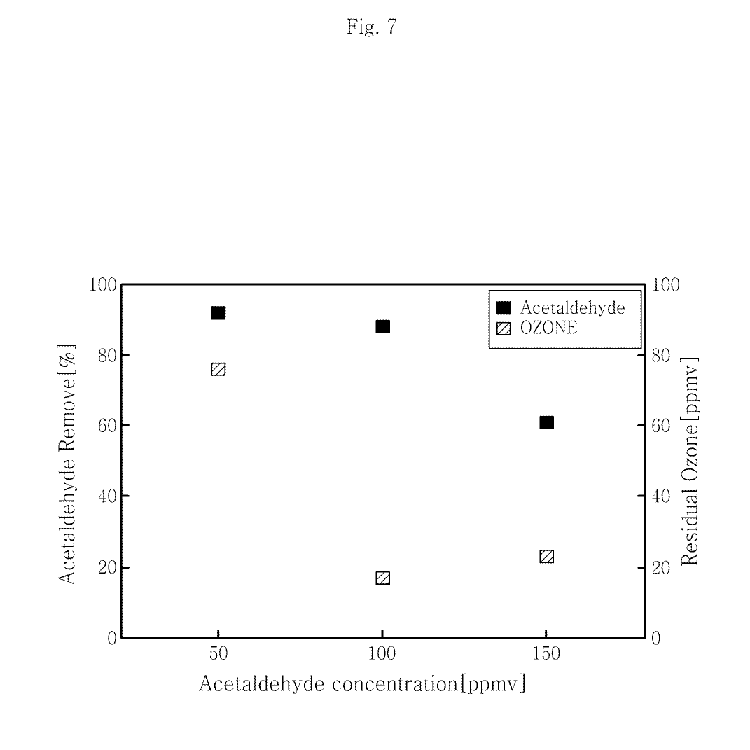

FIG. 7 is a graph which measures the decomposition efficiency of acetaldehyde and the concentration of residual ozone, when the concentration of acetaldehyde exceeds the decomposable critical concentration by ozone. Detection of the concentration of acetaldehyde and ozone was performed FT-IR Spectrometer and a detecting unit of the FT-IR spectrometer was located in a connection path between the oxidation decomposing catalyst device and the discharge end.

Specifically, 250 ppmv of ozone was provided to the oxidation decomposing catalyst device, and 50, 100 and 150 ppmv of acetaldehydes were decomposed by ozone respectively. It was shown that the decomposition efficiency in 50 ppmv of acetaldehyde was high, and the concentration of residual ozone was high, therefore, it is assured that 250 ppmv of ozone is sufficient to decompose 50 ppmv of acetaldehyde. It was shown that the decomposition efficiency in 100 ppmv of acetaldehyde was high, but the concentration of residual ozone was low. Further, it was shown that the decomposition efficiency in 150 ppmv of acetaldehyde was lowered to 60%, and the concentration of residual ozone was low too.

Thus, it was assured that the decomposition efficiency and the concentration of residual ozone can be decreased when the concentration of acetaldehyde exceeds the decomposable critical concentration by ozone. Therefore, if the concentration of volatile organic compounds which are desorbed is not maintained constantly, the decomposition efficiency can be lowered. When volatile organic compounds are provided as the concentration in a range of the decomposable concentration by ozone, it is assured that the decomposition efficiency of volatile organic compounds is ensured to a certain high level, and the efficiency of the apparatus using them increase substantially.

Reference Symbols

| | |
|---|---|
| 110: inflow portion of contaminated air | |
| 120: absorption/desorption module | |
| 121: inlet portion | 122: absorption portion |
| 122a: absorbent | 123: desorption portion |
| 130: heating device | 140: oxidation decomposing |
| | catalyst device |
| | 150: ozone supply unit |

What is claimed is:

1. An apparatus for decomposing an ultra-low concentration of volatile organic compounds, comprising:
an inflow portion of contaminated air for supplying contaminated air containing volatile organic compounds;
two or more absorption/desorption modules connected to the contaminated air source in parallel;
a heating device provided at a circumference of each absorption/desorption module; and
an oxidation decomposing catalyst device for reacting volatile organic compounds discharging from the absorption/desorption modules with oxygen atoms (O*) in an activated state so that the volatile organic compounds are oxidized and decomposed,
wherein each absorption/desorption module alternately performs an absorption process and a desorption process, and the absorption/desorption modules perform different processes at the same time,
wherein the heating device comprises a temperature control unit,
wherein the temperature control unit controls a temperature in order to constantly maintain a concentration of the volatile organic compounds which are discharged from the absorption/desorption module and supplied to the catalyst device,
wherein the concentration (C) of the discharged and supplied volatile organic compounds is within a range of a following mathematical equation 1.
0.8*Cₒ≦C≦1.2*Cₒ [Mathematical equation 1]
(Cₒ is a mean concentration of the volatile organic compounds which are discharged from the absorption/desorption module)

2. The apparatus for decomposing an ultra-low concentration of volatile organic compounds according to claim 1,
wherein the controlling of temperature by the temperature control unit comprises setting-up a start temperature (Tₛ) and end temperature (Tₑ), and then, in at least one heating periods, which are intervals between the start temperature and end temperature, and raising the temperature at a specific rate per 1 minute,
wherein the start temperature and the end temperature have a relation according to a following mathematical equation 2.
Tₛ+A*t=Tₑ [Mathematical equation 2]
wherein “A” is a rate of temperature elevation per 1 minute, and “t” is total time (minutes) of the heating periods, and the rate of temperature elevation per 1 minute is 0.1° C.˜8° C.

3. The apparatus for decomposing an ultra-low concentration of volatile organic compounds according to claim 2,
wherein the controlling temperature by the temperature control unit further comprises maintaining the temperature in at least one temperature maintaining periods, and the temperature maintaining periods locate in between heating periods or after a heating period.

4. The apparatus for decomposing an ultra-low concentration of volatile organic compounds according to claim 1,
wherein the absorption/desorption module comprises an inlet portion, an absorption portion and a desorption portion having a sealed chamber shape and subsequently arranged to be adjacent to each other,
wherein an absorbent for absorbing volatile organic compounds is provided in the absorption portion, and
wherein the desorption portion temporarily stores volatile organic compounds desorbed from the absorbent.

5. The apparatus for decomposing an ultra-low concentration of volatile organic compounds according to claim 4,
wherein the absorbent is zeolite.

6. The apparatus for decomposing an ultra-low concentration of volatile organic compounds according to claim 1,
wherein for the absorption/desorption module which performs the desorption process, the supply of a contaminated air is blocked and the heating device is operated, and for the absorption/desorption module which performs the absorption process, a contaminated air is supplied and the operation of the heating device is stopped.

7. The apparatus for decomposing an ultra-low concentration of volatile organic compounds according to claim 1,
wherein an ozonolysis catalyst for decomposing ozone to generate oxygen atoms (O*) in an activated state is provided in the oxidation decomposing catalyst device, and
wherein an ozone supply unit for supplying ozone to the oxidation decomposing catalyst device is further provided at one side of the oxidation decomposing catalyst device.

8. The apparatus for decomposing an ultra-low concentration of volatile organic compounds according to claim 7,
wherein the ozonolysis catalyst is any one selected from the group consisting of MnO₂, NiO, CoO, Fe₂O₃, V₂O₅, AgO₂, and their mixtures.

9. A method for decomposing ultra-low concentration of volatile organic compounds in the air, comprising:
absorbing and desorbing volatile organic compounds in the air by using two or more modules and supplying the absorbed or desorbed volatile organic compounds; and
decomposing the supplied volatile organic compounds by reacting the supplied volatile organic compounds with oxygen atoms (O*) in an activated state;
wherein the absorbing and desorbing processes are alternately performed in different modules, and the absorbing and desorbing processes are performed at the same time by different modules so that while one module performs the absorbing process, another module performs the desorbing process to regenerate an absorbent, thereby successively performing the absorbing and desorbing processes,
wherein the desorbing and supplying are carried out so that a concentration of the volatile organic compounds may be constantly maintained to be within a range of following mathematical equation 1.
0.8*Cₒ≦C≦1.2*Cₒ [Mathematical equation 1]
(Cₒ is a mean concentration of the volatile organic compounds which are discharged from the absorption/desorption module and supplied to the oxygen atoms)

10. The method according to claim 9,
wherein the supplying is transferring the volatile organic compounds by heating the absorption/desorption module,
wherein the heating is setting-up a start temperature (Tₛ) and end temperature (Tₑ), and then, in at least one heating periods, which are intervals between the start temperature and end temperature, and raising the temperature at a specific rate per 1 minute,
wherein the start temperature and the end temperature have a relation according to a following mathematical equation 2.
Tₛ+A*t=Tₑ [Mathematical equation 2]
wherein “A” is a rate of temperature elevation per 1 minute, and “t” is total time (minutes) of the heating periods, and the rate of temperature elevation per 1 minute is 0.1° C.˜8° C.

11. The method according to claim 10,
wherein the heating further comprises maintaining the temperature in at least one temperature maintaining periods, and the temperature maintaining periods locate in between heating periods or after a heating period

12. The method according to claim 11,
wherein the heating periods are one minute to one hundred minutes, and the temperature maintaining periods are one minute to sixty minutes.

13. The method according to claim 9,
wherein a pressure of the module in desorbing is 0.5˜0.9 atm,
wherein the desorbing is performed by providing a carrier gas to the module at a 0.1˜2 L/min of flow rate,
wherein the carrier gas is hydrogen, helium, argon, or nitrogen gas.

14. The method according to claim 11,
wherein the start temperature is 20˜30° C., and the end temperature is 110˜130° C.,
wherein the rate of the temperature elevation per 1 minute is 0.7˜1.3° C.,
wherein the heating period is 80˜100 minutes, and the temperature maintaining period is 15˜25 minutes after the heating period,
wherein a pressure of the module in desorbing may be 0.75˜0.85 atm,
wherein the desorbing is performed by providing a nitrogen gas to the module at a 0.8˜1.2 L/min of flow rate.

15. The method according to claim 11,
wherein the start temperature is 20˜30° C., and the end temperature is 130˜150° C.,
wherein a number of the heating periods may be four or five,
wherein the rate of the temperature elevation per 1 minute may be 35° C.,
wherein each of the heating periods is 4˜6 minutes, and each of the temperature maintaining periods which is located between the heating periods is 13˜17 minutes,
wherein a pressure of the module in desorbing is 0.75˜0.85 atm,
wherein the desorbing is performed by providing a nitrogen gas to the module at a 0.4˜0.6 L/min of flow rate.

16. The method according to claim 9, wherein the module comprises an absorbent therein.

17. The method according to claim 16, wherein the absorbent is zeolite.

18. The method according to claim 9, wherein the number of modules is two.

19. The method according to claim 9,
wherein the oxygen atoms (O*) in an activated state are generated by a reaction of an ozonolysis catalyst and ozone.

20. The method according to claim 13,
wherein the ozonolysis catalyst is selected from the group consisting of MnO₂, NiO, CoO, Fe₂O₃, V₂O₅, AgO₂, and mixtures thereof.
